(19) United States
(12) Patent Application Publication
(10) Pub. No.: US 2026/0027824 A1
(43) Pub. Date: Jan. 29, 2026

(54) LIQUID LEAKAGE DETECTOR AND INK JET RECORDING APPARATUS

(71) Applicant: SEIKO EPSON CORPORATION, Tokyo (JP)

(72) Inventors: Kazushi ARUGA, Matsumoto-shi (JP); Jun Sato, Shiojiri-shi (JP); Kohei Kumamoto, Shiojiri-shi (JP)

(73) Assignee: SEIKO EPSON CORPORATION, Tokyo (JP)

(21) Appl. No.: 19/277,848

(22) Filed: Jul. 23, 2025

(30) Foreign Application Priority Data
Jul. 24, 2024 (JP) 2024-118317
Nov. 5, 2024 (JP) 2024-193627

(51) Int. Cl. B41J 2/125; B41J 2/175

(52) U.S. Cl. CPC B41J 2/125; B41J 2/175

(57) ABSTRACT

A liquid leakage detector provided inside an ink jet recording apparatus includes a first substrate provided with a pair of electrode terminals that function as a first ink detector, a second substrate provided with another pair of electrode terminals that function as a second ink detector, and a control board provided with a detection circuit configured to detect liquid leakage. The first substrate, the second substrate, and the control board are connected in series in this order, and the first substrate is not electrically directly connected to the control board. The detection circuit detects liquid leakage by detecting, through the second substrate, a short circuit between the pair of electrode terminals or a short circuit between the other pair of electrode terminals.

The present application is based on, and claims priority from JP Application Serial Number 2024-118317, filed Jul. 24, 2024 and JP Application Serial Number 2024-193627, filed Nov. 5, 2024, the disclosures of which are hereby incorporated by reference herein in their entirety.

### BACKGROUND

### 1. Technical Field

The present disclosure relates to a liquid leakage detector and an ink jet recording apparatus.

### 2. Related Art

JP-A-2007-160825 describes a technique for an ink leakage detection mechanism of a printer. The technique described in JP-A-2007-160825 uses a pair of electrode terminals as an ink detector.

To detect ink leakage with higher accuracy, ink detectors are provided inside the printer at multiple portions where the ink leakage is likely to occur.

Traditionally, the ink detectors are individually connected to a control unit by wiring lines. This causes a problem that the wiring lines connecting the ink detectors to the control unit occupy a large portion of the inner space of the printer although the printer has a limited inner space. Thus, there is a demand for more efficient use of the inner space of the printer.

### SUMMARY

The present disclosure can be implemented as the following aspects.

An aspect of the present disclosure provides a liquid leakage detector provided inside an ink jet recording apparatus. The liquid leakage detector comprises a first substrate provided with a pair of electrode terminals that function as a first ink detector, a second substrate provided with another pair of electrode terminals that function as a second ink detector, and a control board provided with a detection circuit configured to detect liquid leakage. The first substrate, the second substrate, and the control board are electrically connected in series in this order, and the first substrate is not electrically directly connected to the control board. The detection circuit detects liquid leakage by detecting, through the second substrate, that a potential difference between the pair of electrode terminals or between the other pair of electrode terminals falls below a predetermined threshold value.

Another aspect of the present disclosure provides an ink jet recording apparatus. The ink jet recording apparatus includes a liquid flow unit, an ejection execution unit, a case housing, a control unit, and a liquid leakage detector. The liquid leakage detector includes a first substrate provided with a pair of electrode terminals that function as a first ink detector, a second substrate provided with another pair of electrode terminals that function as a second ink detector, and a control board provided with a detection circuit configured to detect liquid leakage. The first substrate, the second substrate, and the control board are electrically connected in series in this order, and the first substrate is not electrically directly connected to the control board. The detection circuit detects liquid leakage by detecting, through the second substrate, that a potential difference between the pair of electrode terminals or between the other pair of electrode terminals falls below a predetermined threshold value.

### BRIEF DESCRIPTION OF THE DRAWINGS

FIG. 1 is a schematic perspective view illustrating an external configuration of a printer including a liquid leakage detector according to the present embodiment.

FIG. 2 is a schematic view of the printer viewed from the +Y direction side.

FIG. 3 is an explanatory view illustrating a circuitry of the liquid leakage detector.

FIG. 4 is an explanatory view illustrating a schematic configuration of wiring lines of a first substrate and a second substrate and an ink detector.

FIG. 5 is an explanatory view of how to detect ink leakage.

FIG. 6 is an explanatory view of how to detect a conduction failure with a substrate.

FIG. 7 is another explanatory view of how to detect a conduction failure with a substrate.

FIG. 8 is an explanatory view of arrangement of electrode terminals on the first substrate and the second substrate.

FIG. 9 is an explanatory view of the first substrate and the second substrate viewed from a side opposite to FIG. 8.

FIG. 10 is an explanatory view illustrating an example of arrangement of the substrates according to a second embodiment.

FIG. 11 is an explanatory view illustrating an example of arrangement of the substrates according to a third embodiment.

### DESCRIPTION OF EMBODIMENTS

### A. First Embodiment

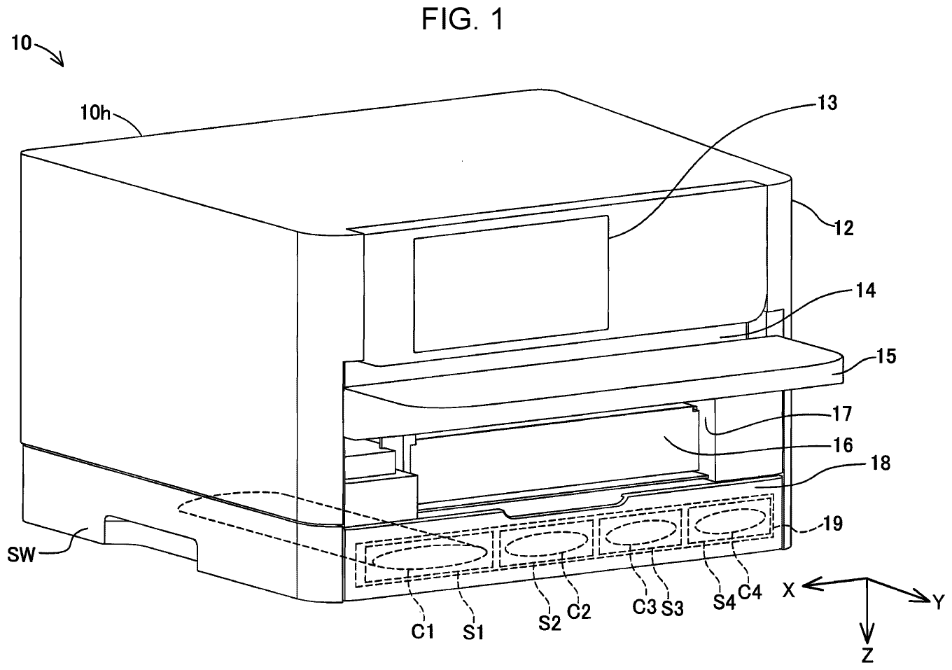

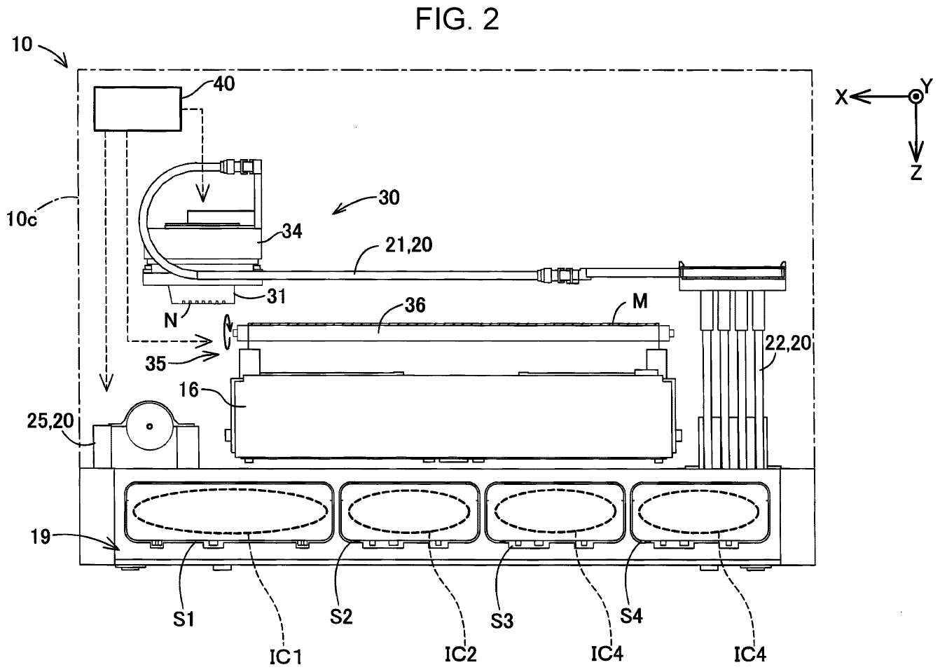

FIG. 1 is a schematic perspective view illustrating an external configuration of a printer 10 including a liquid leakage detector 70 according to the embodiment. In FIG. 1, an XYZ orthogonal coordinate system is set. The Z axis extends in the gravity direction. The +Z direction is the gravity direction. The Z direction corresponds to the vertical direction of the printer 10. The X axis and the Y axis are along a horizontal plane. The Y axis extends in the front/rear direction of the printer 10. The +Y direction is a direction from the rear surface side to the front surface side of the printer 10. The X axis extends in the left-right direction of the printer 10. The +X direction corresponds to a direction from the right side to the left side when the printer 10 is viewed from the front. FIG. 2 is a schematic view of the printer 10 viewed from the +Y direction side without a housing 10h and a cover member 18.

The printer 10 includes the housing 10h, a liquid flow unit 20 located in the housing 10h, an ejection execution unit 30, a medium transport unit 35, a control unit 40, and a liquid leakage detector 70. In FIG. 1, the liquid flow unit 20, the ejection execution unit 30, the medium transport unit 35, the control unit 40, and the liquid leakage detector 70 are not illustrated. In FIG. 2, the liquid leakage detector 70 is not illustrated.

The printer 10 is an ink jet printer. The printer 10 is also referred to as an “ink jet recording apparatus”. The printer 10 forms an image by ejecting ink, which is an example of liquid, to print ink dots on a printing sheet, which is a medium. The medium onto which the printer 10 ejects ink is not limited to a printing sheet, and may be plastic, film, fiber, fabric, leather, metal, glass, wood, ceramics, or other materials.

As illustrated in FIG. 1, the housing 10h is a substantially rectangular parallelepiped hollow casing forming the exterior of the printer 10. A front surface portion 12 of the housing 10h has an operation panel 13, a medium outlet 14, a paper discharge tray 15, a paper feed tray 16, an insertion opening 17, the cover member 18, and a case housing 19.

The operation panel 13 functions as a display that displays information and as an input portion that receives a user's operation. The operation panel 13 is, for example, a touch panel. The medium outlet 14 is an outlet of the medium discharged from the inside of the printer 10. The medium outlet 14 is a slit-shaped opening having a large width in the X direction. The paper discharge tray 15 is located below the medium outlet 14. The paper discharge tray 15 receives the medium discharged from the medium outlet 14.

The sheet feed tray 16 houses a medium. The insertion opening 17 is an opening through which the sheet feed tray 16 is inserted into the housing 10h. The insertion opening 17 is a substantially rectangular opening having a large width in the X direction and is located below the paper discharge tray 15. To supply the medium, the user puts the medium in the paper feed tray 16 that has been pulled out in the +Y direction through the insertion opening 17. Then, the user puts the paper feed tray 16 in the printer 10 through the insertion opening 17.

The cover member 18 is a plate-shaped member formed of resin and forms a portion of the exterior of the printer 10. The cover member 18 has a substantially rectangular shape having a large width in the X direction. The cover member 18 is located below the sheet feed tray 16. The cover member 18 has a claw portion (not illustrated) on its outer peripheral edge and is detachably attached to the housing 10h. The cover member 18 covers cases S1 to S4 housed in the case housing 19.

The case housing 19 is a space in the housing 10h for accommodating the cases S1 to S4. The cases S1 to S4 are tray-like containers. The cases S1 to S4 are used to attach the ink cartridges IC1 to IC4 to the printer 10. The cases S1 to S4 are arranged in the X direction in the case housing 19. The cases S1 to S4 are attached to the printer 10 while holding the ink cartridges IC1 to IC4. The ink cartridges IC1 to IC4 are so-called ink packs. The ink cartridges IC1 to IC4 store black, cyan, magenta, and yellow inks, respectively. To load the ink cartridge, the user puts the ink cartridge in the case that has been pulled out in the +Y direction. Then, the user inserts the case into the case housing 19.

As illustrated in FIG. 2, the liquid flow unit 20 includes tubes 21, flow pipes 22, and a pump 25. The tubes 21 are arranged in the Y direction. The tubes 21 are connected to a print head 31. The tubes 21 are connected to the flow pipes 22. When the pump 25 operates, the ink inside the ink cartridges IC1 to IC4 is pushed out to the flow pipes 22. The ink in the ink cartridges IC1 to IC4 flows through the flow pipes 22 and the tubes 21 to the print head 31.

The ejection execution unit 30 includes the print head 31 and a carriage 34. The print head 31 receives the ink via the tubes 21 of the liquid flow unit 20. The print head 31 has nozzles N for ejecting the ink supplied from the liquid flow unit 20 downward. The print head 31 moves together with the carriage 34 and ejects ink supplied from the ink cartridges IC1 to IC4 onto a medium. The carriage 34 having the print head 31 is reciprocated in the X direction, which is a main scanning direction, by a drive mechanism (not illustrated).

The medium transport unit 35 transports a medium M in a sub-scanning direction under the control of the control unit 40. The sub-scanning direction is the Y direction. The medium transport unit 35 includes a transport roller 36 stretching in the X direction below the print head 31. The paper feed tray 16 is located below the transport roller 36.

When the printing process is executed, the control unit 40 causes the medium transport unit 35 to transport the medium M in the sub-scanning direction. Furthermore, the control unit 40 reciprocates the carriage 34 to reciprocate the print head 31 in the main scanning direction along the transport roller 36 at a position above the transport roller 36. The control unit 40 causes the print head 31 to discharge ink droplets onto the printing surface of the medium M at a timing determined based on the printing data. Thus, the ink dots are recorded on the medium M transported by the medium transport unit 35 at positions determined based on the print data, forming an image based on the print data.

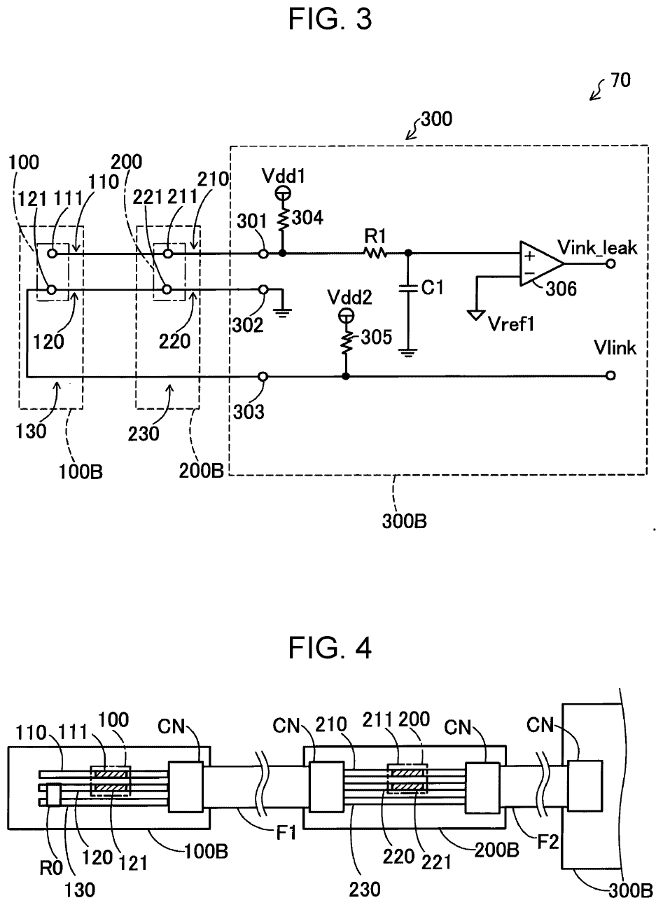

FIG. 3 is an explanatory view illustrating a circuitry of the liquid leakage detector 70 provided inside the printer 10. FIG. 4 is an explanatory view illustrating a schematic configuration of wiring lines of the first substrate 100B and the second substrate 200B and the ink detector. The liquid leakage detector 70 is configured to detect ink leakage in the printer 10. The liquid leakage detector 70 includes a first ink detector 100, a second ink detector 200, and a detection circuit 300.

The first ink detector 100 illustrated in FIG. 4 detects ink leakage in the printer 10. The first ink detector 100 includes a pair of electrode terminals provided on the first substrate 100B. The first substrate 100B is provided with wiring lines 110, 120, and 130, electrode terminals 111 and 121, a connector CN, and a resistor R0. The first substrate 100B is a printed board. The wiring lines 110, 120, and 130 are formed by printing a wiring conductor on the first substrate 100B. The wiring lines 110, 120, and 130 are arranged in parallel. The wiring lines 110, 120, and 130 are covered with a resist which is a coating material. The electrode terminal 111 is formed by exposing a portion of the conductor portion of the wiring line 110. The electrode terminal 121 is formed by exposing a portion of the conductor portion of the wiring line 120. The electrode terminals 111 and 121 may be formed as pads by routing the wiring lines 110 and 120 in the first substrate 100B using through holes or the like. The electrode terminals 111 and 121 function as the first ink detector 100. The connector CN enables the wiring lines 110, 120, and 130 to be electrically connected to other wiring lines. The wiring line 110 is also referred to as a “first wiring line”. The wiring line 120 is also referred to as a “second wiring line”. The electrode terminals 111 and 121 are also referred to as a “pair of electrode terminals”. Further, one end of the wiring line 120 and one end of the wiring line 130 are electrically connected to each other by using a resistor R0 of 0 ohm. For example, the first ink detector 100 is located below the connection between the case S1 and the liquid flow unit 20 in the case housing 19 (see FIG. 2). The first ink detector 100 is located such that the electrode terminals 111 and 121 face the bottom surface of the case housing 19.

The second ink detector 200 illustrated in FIG. 4 detects ink leakage in the printer 10. The second ink detector 200 includes a pair of electrode terminals provided on the second substrate 200B. The second substrate 200B is provided with wiring lines 210, 220, and 230, electrode terminals 211 and 221, and two connectors CN. The second substrate 200B is a printed board. The wiring lines 210, 220, and 230 are formed by printing a wiring conductor on the second substrate 200B. The wiring lines 210, 220, and 230 are arranged in parallel. The wiring lines 210, 220, and 230 are covered with a resist which is a coating material. The electrode terminal 211 is formed by exposing a portion of the conductor portion of the wiring line 210. The electrode terminal 221 is formed by exposing a portion of the conductor portion of the wiring line 220. The electrode terminals 211 and 221 may be formed as pads by routing the wiring lines 210 and 220 in the second substrate 200B using through holes or the like. The electrode terminals 211 and 221 function as the second ink detector 200. The connector CN enables the wiring lines 210, 220, and 230 to be electrically connected to other wiring lines. The wiring line 210 is also referred to as a “third wiring line”. The wiring line 220 is also referred to as a “fourth wiring line”. The electrode terminals 211 and 221 are also referred to as “another pair of electrode terminals”.

For example, the second ink detector 200 is located below the connection between the case S2 and the liquid flow unit 20 in the case housing 19 (see FIG. 2). The second ink detector 200 is located such that the electrode terminals 211 and 221 face the bottom surface of the case housing 19.

As illustrated in FIG. 4, the first substrate 100B and the second substrate 200B are connected via a cable F1. The second substrate 200B and the control board 300B are connected via a cable F2. The cables F1 and F2 are multi-core flat cables. The control board 300B is located, for example, inside the control unit 40.

The detection circuit 300 illustrated in FIG. 3 detects a short circuit between the electrode terminals 111 and 121 or a short circuit between the electrode terminals 211 and 221, resulting in detection of ink leakage in the printer 10. When ink, which is a conductor, leaks in the vicinity of the electrode terminals 111 and 121, the ink causes a short circuit between the electrode terminals 111 and 121. The same applies to a short circuit between the electrode terminals 211 and 221. The detection circuit 300 is provided on the control board 300B.

The detection circuit 300 includes a leakage signal terminal 301, a ground terminal 302, a link signal terminal 303, a first pull-up resistor 304, a second pull-up resistor 305, a comparator 306, a resistor R1, a capacitor C1, a power supply Vdd1, and a power supply Vdd2.

One end of the first pull-up resistor 304 is connected to the leakage signal terminal 301. The leakage signal terminal 301 is connected to the wiring line 210 of the second substrate 200B via the cable F2. The other end of the first pull-up resistor 304 is connected to the power supply Vdd1. The potential of the power supply Vdd1 is a signal potential of the high potential side. A constant voltage is applied to the leakage signal terminal 301 from the power supply Vdd1 through the first pull-up resistor 304. Thus, the potential of the leakage signal terminal 301 is fixed. The leakage signal terminal 301 is connected to the positive input terminal of the comparator 306 via an RC circuit constituted by the resistor R1 and the capacitor C1. The resistor R1 and the capacitor C1 are provided to output the time integral of the input to the leakage signal terminal 301 to the comparator 306. The ground terminal 302 is connected to the wiring line 220 of the second substrate 200B via the cable F2. The ground terminal 302 is grounded.

A signal from the leakage signal terminal 301 is inputted to a positive input terminal of the comparator 306. The negative input terminal of the comparator 306 is signal-grounded. The potential of the signal-grounded portion is a reference potential Vref1. The reference potential Vref1 is a potential of the low potential side and is any voltage. The reference potential Vref1 is set to a voltage lower than the voltage applied by the power supply Vdd1. When the potential of the signal inputted to the positive input terminal is lower than the reference potential Vref1, the comparator 306 outputs a Low signal as an output Vink_leak. When the potential of the signal inputted to the positive input terminal (the signal inputted from the leakage signal terminal 301) is higher than the reference potential Vref1, the comparator 306 outputs a Hi signal as an output Vink_leak. The output Vink_leak from the comparator 306 is inputted to a processor (not illustrated) including an interface capable of receiving a digital signal. The processor (not illustrated) is, for example, a processor that functions as the control unit 40.

One end of the second pull-up resistor 305 is connected to the link signal terminal 303. The link signal terminal 303 is connected to the wiring line 230 of the second substrate 200B via the cable F2. The other end of the second pull-up resistor 305 is connected to the power supply Vdd2. A constant voltage is applied to the link signal terminal 303 from the power supply Vdd2 via the second pull-up resistor 305. Thus, the potential of the link signal terminal 303 is fixed. The voltage applied from the power supply Vdd2 is set to be higher than the ground level.

The leakage signal terminal 301 of the detection circuit 300 is connected to one end of the wiring line 210 of the second substrate 200B via the cable F2. The ground terminal 302 of the detection circuit 300 is connected to one end of the wiring line 220 of the second substrate 200B via the cable F2. The other end of the wiring line 210 of the second substrate 200B is connected to one end of the wiring line 110 of the first substrate 100B via the cable F1. The other end of the wiring line 210 is an end of the wiring line 210 that is not connected to the leakage signal terminal 301. The end of the wiring line 210 includes an edge of the wiring line 210 but is not limited to the edge of the wiring line 210. The other end of the wiring line 220 of the second substrate 200B is connected to one end of the wiring line 120 of the first substrate 100B via the cable F1. The other end of the wiring line 220 is an end of the wiring line 220 that is not connected to the ground terminal 302. The end of the wiring line 220 includes an edge of the wiring line 220 but is not limited to the edge of the wiring line 220.

In this way, the first substrate 100B, the second substrate 200B, and the control board 300B are connected in series in this order. The first substrate 100B is not electrically directly connected to the control board 300B. Being electrically directly connected means being connected using a cable, a harness, or the like without other components in between.

Furthermore, the link signal terminal 303 of the detection circuit 300 is connected to one end of the wiring line 230 of the second substrate 200B via the cable F2. The other end of the wiring line 230 of the second substrate 200B is connected to one end of the wiring line 130 of the first substrate 100B via the cable F1. Furthermore, as described above, the other end of the wiring line 120 and the other end of the wiring line 130 are electrically connected to each other using the resistor R0 of 0 ohm. The other end of the wiring line 120 is an end of the wiring line 120 that is not connected to the wiring line 220. The end of the wiring line 120 includes the edge of the wiring line 120 but is not limited to the edge of the wiring line 120. The other end of the wiring line 130 is an end of the wiring line 130 that is not connected to the wiring line 230. The end of the wiring line 130 includes the edge of the wiring line 130 but is not limited to the edge of the wiring line 130. In this way, the wiring line 230, the wiring line 130, the wiring line 120, and the wiring line 220 are electrically connected in series in this order. The wiring line 230, the wiring line 130, the wiring line 120, and the wiring line 220 constitute one current path. The wiring line 130 is also referred to as a “fifth wiring line”. The wiring line 230 is also referred to as a “sixth wiring line”.

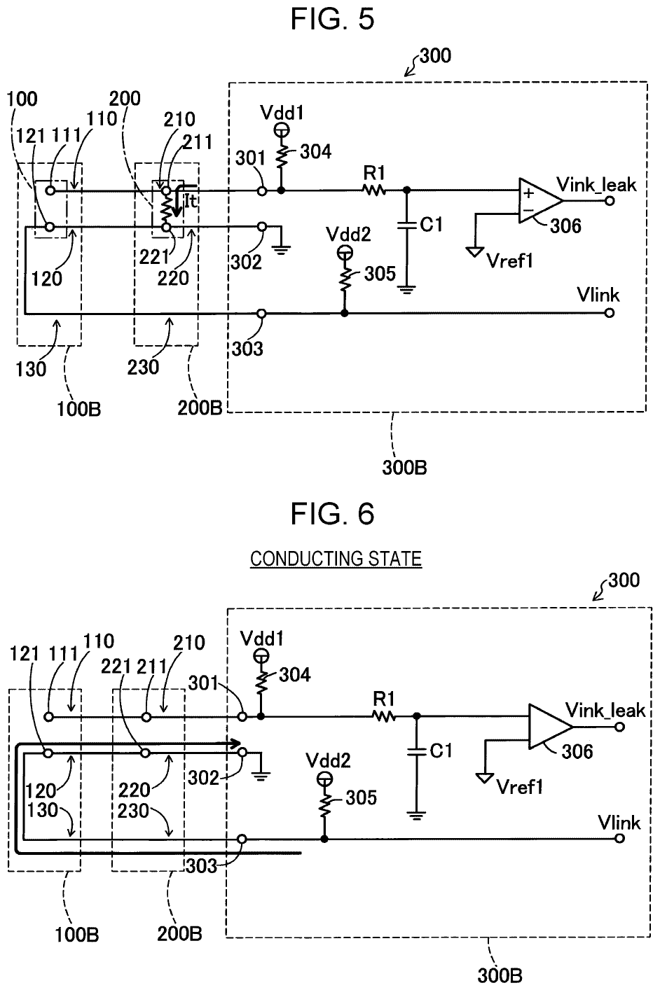

FIG. 5 is an explanatory view of how to detect ink leakage. Here, it is assumed that ink leakage occurred at the vicinity of the electrode terminals 211 and 221 of the second substrate 200B. The ink leakage means that the ink leaks from the inside of the ink cartridge IC1 to IC4, the liquid flow unit 20, or other components.

When the leaked ink causes a short circuit between the electrode terminals 211 and 221 of the second substrate 200B, a short-circuit current It flows between the electrode terminals 211 and 221. This causes a voltage drop in the wiring line 210, and the potential of the input signal inputted to the positive input terminal of the comparator 306 decreases. When the potential of the input signal inputted to the positive input terminal of the comparator 306 becomes lower than the reference potential Vref1, the comparator 306 outputs a Low signal as an output Vink_leak. The fact that the potential of the input signal inputted to the positive input terminal of the comparator 306 becomes lower than the reference potential Vref1 indicates that both the potential difference between the electrode terminals 211 and 221 and the potential difference between the electrode terminals 111 and 121 fall below the predetermined thresholds. In this case, the comparator 306 outputs a Low signal as the output Vink_leak. Ink leakage in the printer 10 can be detected with such a simple configuration. Upon reception of the Low signal as the output Vink_leak, the processor (not illustrated) can detect the occurrence of ink leakage in any one of the first substrate 100B and the second substrate 200B. In addition, for example, the processor (not illustrated) can notify the user of detection of ink leakage.

In the example illustrated in FIG. 5, the ink leakage occurred in the vicinity of the electrode terminals 211 and 221 on the second substrate 200B. However, the comparator 306 also outputs a Low signal as the output Vink_leak when a voltage drop was caused by a short circuit between the electrode terminals 111 and 121 on the first substrate 100B caused by leaked ink.

In the present embodiment, the first substrate 100B, the second substrate 200B, and the control board 300B are electrically connected in series in this order, and the first substrate 100B is not electrically directly connected to the control board 300B. Thus, the above configuration requires a smaller space occupied by the wiring lines connecting the substrates in the printer 10 than the configuration in which the first substrate 100B and the second substrate 200B are each electrically directly connected to the control board 300B. This allows more efficient use of the space inside the printer 10. In addition, the substrates provided with the ink detectors can be readily located away from each other by adjustment of the length of the cable. In addition, since the liquid leakage detector 70 has a simple configuration, the liquid leakage detector 70 can be readily introduced into various types of printers. Even when two or more substrates are provided with the ink detector, the control board 300B only has to receive a signal from any one of the substrates, preventing overloading of the communication resources of the control board 300B.

FIG. 6 is an explanatory view of other functions of the detection circuit 300 than the function of detecting ink leakage. In this embodiment, the detection circuit 300 detects a conduction failure with one or more of the substrates among the plurality of substrates connected to the control board 300B. As in the related art in which the first substrate 100B and the second substrate 200B are electrically directly connected to the control board 300B, the detection circuit 300 can determine whether the control board is electrically connected to the substrate provided with the ink detector, for example, based on the presence or absence of a signal from the ink detectors. However, in the present embodiment, the first substrate 100B is not directly connected to the control board 300B. Thus, one current path constituted by the wiring line 230, the wiring line 130, the wiring line 120, and the wiring line 220 is used to detect a conduction failure with one or more substrates. The conduction failure refers to, for example, a state in which the cable is disconnected from the connector and is not electrically connected to any of the substrates. For ease of understanding of the technique, it is assumed that ink leakage has not occurred.

As illustrated in FIG. 6, the wiring lines 230, the wiring line 130, the wiring line 120, and the wiring line 220 are connected in series. The ground terminal 302 connected to one end of the wiring line 220 is grounded. One end of the wiring line 230 is connected to the link signal terminal 303. A signal inputted to the link signal terminal 303 is inputted to a processor (not illustrated) including an interface capable of receiving a digital signal as an output Vlink. When one current path constituted by the wiring line 230, the wiring line 130, the wiring line 120, and the wiring line 220 is electrically conducting, the potential of the signal inputted to the link signal terminal 303 is at the ground level. Thus, the potential of the signal output as the output Vlink is at the ground level.

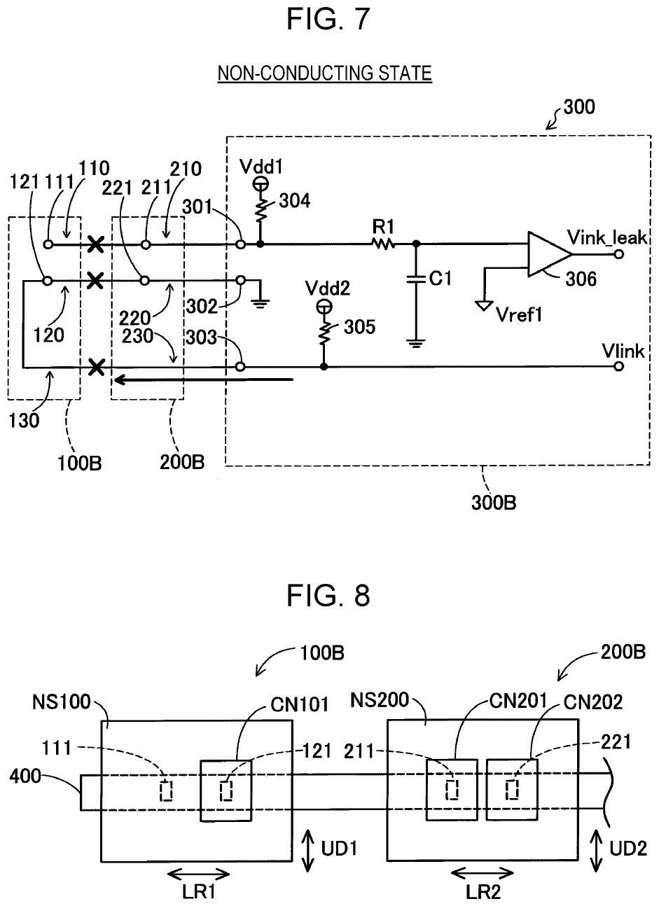

As illustrated in FIG. 7, when the cable F1 connecting the first substrate 100B and the second substrate 200B is disconnected from the connector of any one of the first substrate 100B and the second substrate 200B, the one current path is not electrically conducting. In this case, the potential of the signal output as the output Vlink increases and becomes equal to the output voltage of the power supply Vdd2. The processor (not illustrated) can detect a conduction failure with the first substrate 100B or the second substrate 200B connected to the control board 300B based on the change in the output Vlink.

As described above, in this embodiment, a conduction failure with one or more of the substrates connected to the control board 300B can be readily detected. If the cable is disconnected from the connector, detection of ink leakage is impossible. Thus, when the detection circuit 300 detects a conduction failure, for example, a processor (not illustrated) can notify a user of the conduction failure. The number of wiring lines on the first substrate 100B and the second substrate 200B can be reduced by using the wiring lines 110 and 210 for both the detection of occurrence of ink leakage and the detection of conduction failure with substrates. The above-described configuration for detecting a conduction failure is more advantageous when the number of substrates connected to the control board 300B is larger.

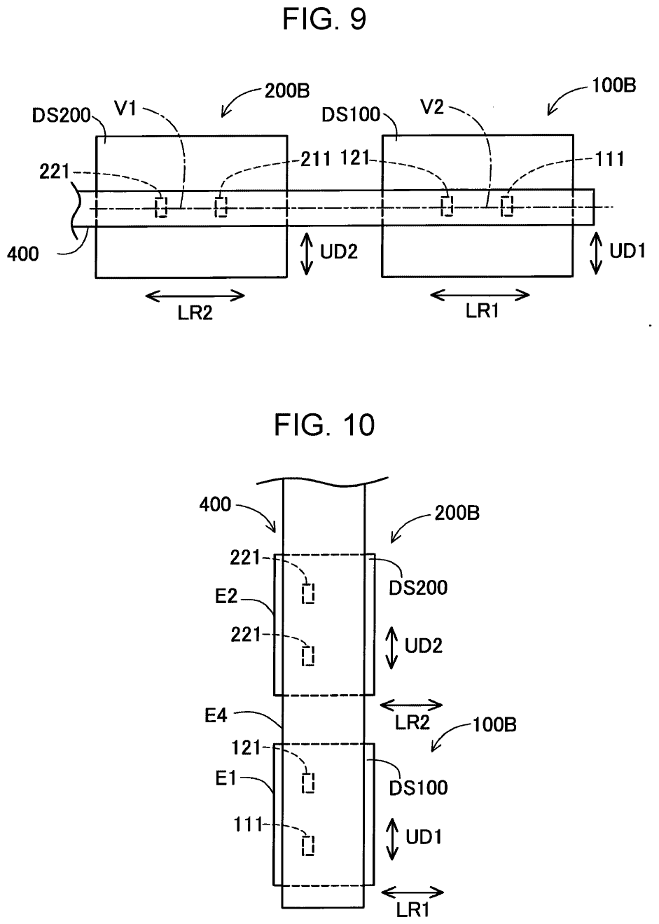

FIG. 8 and FIG. 9 are explanatory views illustrating the arrangement of the electrode terminals on the first substrate 100B and the second substrate 200B. FIG. 9 is an explanatory view when the first substrate 100B and the second substrate 200B are viewed from a side opposite to FIG. 8. In FIG. 4, the relationship between the wiring lines of the first substrate 100B and the second substrate 200B and the electrode terminals is schematically illustrated, but the electrode terminals are preferably arranged as illustrated in FIGS. 8 and 9 when actually used.

In the illustrated example, the liquid leakage detector 70 includes the first ink detector 100, the second ink detector 200, the detection circuit 300, and the liquid absorber 400. In FIGS. 8 and 9, the detection circuit 300 is not illustrated.

The first ink detector 100 includes a pair of electrode terminals provided on the first substrate 100B. As illustrated in FIGS. 8 and 9, the first substrate 100B is a printed board having a rectangular shape. In the present embodiment, the longitudinal direction of the first substrate 100B is a left-right direction LR1 of the first substrate 100B. The left-right direction LR1 of the first substrate 100B is also referred to as a “first direction”. A direction intersecting the longitudinal direction of the first substrate 100B, that is, the transverse direction of the first substrate 100B is a vertical direction UD1 of the first substrate. The first substrate 100B is provided with the electrode terminals 111 and 121 and the connector CN101. The electrode terminals 111 and 112 are electrically connected to, for example, other wiring lines by the connector CN101.

As illustrated in FIG. 9, the electrode terminals 111 and 121 are arranged in the left-right direction LR1 on a surface DS100 of the first substrate 100B. The electrode terminals 111 and 121 are located so as to at least partially overlap a virtual center line V1, which is a virtual straight line parallel to the long sides of the first substrate 100B. In other words, the electrode terminals 111 and 121 are arranged side by side in the direction in which the virtual center line V1 extends. In FIG. 9, the virtual center line V1, which is parallel to the long sides of the first substrate 100B, is indicated by a one dot chain line. The virtual center line V1 extends at the center in the transverse direction of the first substrate 100B. The electrode terminals 111 and 121 are arranged at the middle portion in the vertical direction UD1 of the first substrate 100B. In addition, preferably, the electrode terminals 111 and 121 are arranged vertically symmetrically and bilaterally symmetrically on the surface DS100 of the first substrate 100B. The electrode terminals 111 and 121 are constituted by two pads on the surface DS100. The surface DS100 having the electrode terminals 111 and 121 is also referred to as a “first surface”. The virtual center line V1 set on the first substrate 100B is also referred to as a “first virtual center line”. As illustrated in FIG. 8, the connector CN101 is on a surface NS100 of the first substrate 100B. The surface NS100 is an opposite surface from the surface DS100.

The second ink detector 200 includes a pair of electrode terminals provided on the second substrate 200B. The second substrate 200B is a printed board having a rectangular shape. In the present embodiment, the longitudinal direction of the second substrate 200B is a left-right direction LR2 of the second substrate 200B. The left-right direction LR2 of the second substrate 200B is also referred to as a “second direction”. A direction intersecting the longitudinal direction of the second substrate 200B, that is, the transverse direction of the second substrate 200B is a vertical direction UD2 of the second substrate. The second substrate 200B is provided with the electrode terminals 211 and 221 and the connectors CN201 and CN202. The electrode terminals 211 and 212 are electrically connected to, for example, other wiring lines by the connectors CN201 and CN202.

As illustrated in FIG. 9, the electrode terminals 211 and 221 are arranged in the left-right direction LR2 on a surface DS200 of the second substrate 200B. The electrode terminals 211 and 221 at least partially overlap a virtual center line V2. The virtual center line V2 is parallel to the long sides of the second substrate 200B and extends at the center in the transverse direction of the second substrate 200B. In other words, the electrode terminals 211 and 221 are arranged at the middle portion in the vertical direction UD2 of the second substrate 200B. In the present embodiment, the virtual center line V1 and the virtual center line V2 are continuous. In addition, preferably, the electrode terminals 211 and 221 are arranged vertically symmetrically and bilaterally symmetrically on the surface DS200 of the second substrate 200B. The electrode terminals 211 and 221 are constituted by two pads on the surface DS200. The surface DS200 having the electrode terminals 211 and 221 is also referred to as a “second surface”. The virtual center line V2 set on the second substrate 200B is also referred to as a “second virtual center line”.

As illustrated in FIG. 8, the connectors CN201 and CN202 are on the surface NS200 of the second substrate 200B. The surface NS200 is an opposite surface from the surface DS200.

The connector CN101 of the first substrate 100B and the connector CN201 of the second substrate 200B illustrated in FIG. 8 are connected via the cable F1 (see FIG. 4). Thus, the first substrate 100B and the second substrate 200B are electrically connected to each other.

The connector CN202 of the second substrate 200B and the leakage signal terminal 301 of the control board 300B are connected via the cable F2 (see FIG. 4). The connector CN202 of the second substrate 200B and the ground terminal 302 of the control board 300B are connected via the cable F2. Thus, the second substrate 200B and the control board 300B are electrically connected to each other.

The liquid absorber 400 absorbs ink that has leaked inside the printer 10. The liquid absorber 400 is formed of a porous material or a foamed material having water absorbability and has a band-like shape. As the liquid absorber 400, for example, Bell-eater (registered trademark), Bemliese (registered trademark), or SOFRAS (registered trademark) can be used.

The liquid absorber 400 is located below the first substrate 100B and the second substrate 200B in the gravity direction. For example, the first ink detector 100 and the second ink detector 200 are located in the case housing 19. In this case, the liquid absorber 400 is located on the bottom surface of the case housing 19, and the first substrate 100B and the second substrate 200B are located thereon. The first substrate 100B is stacked on the liquid absorber 400 with the surface DS100 having the electrode terminals 111 and 121 facing the liquid absorber 400 and with the left-right direction LR1 of the first substrate 100B being aligned with the longitudinal direction of the liquid absorber 400. The second substrate 200B is stacked on the liquid absorber 400 with the surface DS200 having the electrode terminals 211 and 221 facing the liquid absorber 400 and with the left-right direction 200B of the second substrate LR2 being aligned with the longitudinal direction of the liquid absorber 400. Thus, the electrode terminals 111 and 121 constituting the first ink detector 100 and the electrode terminals 211 and 221 constituting the second ink detector 200 are in contact with the liquid absorber 400.

For example, it is assumed that ink leakage occurs in the vicinity of the electrode terminals 111 and 121. The ink soaks and spreads in the liquid absorber 400. When the ink spreads to a contact area between the liquid absorber 400 and the electrode terminals 111 and 121, the ink causes a short circuit between the electrode terminals 111 and 121. Due to the short circuit between the electrode terminals 111 and 121, the detection circuit 300 detects the occurrence of ink leakage.

Hereinafter, the advantages of placing the pair of electrode terminals at the middle portion in the vertical direction UD1 of the substrate will be described. Here, the first substrate 100B will be described as an example, but the second substrate 200B also has the same advantages.

The first substrate 100B is placed as follows. The operator stacks the first substrate 100B on the liquid absorber 400 such that the left-right direction LR1 of the first substrate 100B is aligned with the longitudinal direction of the liquid absorber 400 and such that a middle portion in the vertical direction UD1 of the first substrate 100B overlaps the middle portion in the transverse direction (width direction) of the liquid absorber 400. The same applies to the second substrate 200B.

The operator needs to consider which side is up or down of the second substrate 200B when placing the second substrate 200B on the liquid absorber 400. However, the second substrate 200B has a rectangular shape, and the connectors CN201 and CN202 are arranged bilaterally symmetrically on the surface NS200. Thus, it is difficult for the operator to determine which side is up or down of the second substrate 200B. The operator might stack the second substrate 200B on the liquid absorber 400 with the top and bottom reversed. If the electrode terminals 211 and 221 are not located at the middle portion of the second substrate, there may be a problem that one or both of the electrode terminals 211 and 221 is not in contact with the liquid absorber 400 when the first substrate 100B is stacked on the liquid absorber 400.

In this embodiment, on the second substrate 200B, the electrode terminals 211 and 221 are arranged vertically symmetrically at the middle portion of the second substrate. With this configuration, when the second substrate 200B is stacked on the liquid absorber 400 with the top and bottom of the substrate 200B reversed, the electrode terminals 211 and 221 are in contact with the liquid absorber 400, although the electrode terminals 211 and 221 are not in the proper positions. Thus, if ink leakage occurs in the vicinity of the electrode terminals 211 and 221, the ink absorbed by the liquid absorber 400 causes a short circuit between the electrode terminals 211 and 221. Thus, the liquid leakage detector 70 can properly detect ink leakage.

In some cases, the connector CN101 is located at the middle in the left-right direction LR1 of the first substrate 100B. In such a case, even when the first substrate 100B is stacked on the liquid absorber 400 with the top and bottom of the first substrate 100B reversed, the electrode terminals 111 and 121 are in contact with the liquid absorber 400, although the electrode terminals 111 and 121 are not in the proper positions. Thus, the ink leakage detection function works properly.

The operator only has to stack the second substrate 200B on the liquid absorber 400 such that the left-right direction LR2 of the second substrate 200B is aligned with the longitudinal direction of the liquid absorber 400 and such that the middle portion in the vertical direction UD2 of the second substrate 200B overlaps the middle portion in the transverse direction of the liquid absorber 400. The positioning of the second substrate 200B is easy.

In the present embodiment, the liquid absorber 400 can be shared by the first substrate 100B and the second substrate 200B for the liquid leakage detection. Thus, the liquid leakage detector 70 can be more readily formed compared to a case in which the liquid absorber is provided for each of the substrates.

### B. Second Embodiment

In the example of the first embodiment, the pair of electrode terminals are arranged bilaterally symmetrically at the middle portion of each of the first substrate 100B and the second substrate 200B. However, the pair of electrode terminals do not have to be arranged bilaterally symmetrically.

FIG. 10 is an explanatory view illustrating an example of arrangement of the substrates according to the second embodiment. In this embodiment, the longitudinal direction of the substrates is a vertical direction, and the transverse direction of the substrates is a left-right direction.

The electrode terminals 111 and 121 are arranged in the vertical direction UD1 on the surface DS100 of the first substrate 100B. The vertical direction UD1 of the first substrate 100B is also referred to as the “first direction”. The electrode terminals 111 and 121 are arranged at the same interval from the center of the first substrate 100B in the vertical direction UD1. Unlike the first embodiment, the electrode terminals 111 and 121 are located closer to one end E1 of the first substrate 100B in the left-right direction LR1. As described above, the electrode terminals 111 and 121 are arranged vertically symmetrically and bilaterally asymmetrically on the surface DS100. The same applies to the electrode terminals 211 and 221 of the second substrate 200B.

In this embodiment, the first substrate 100B and the second substrate 200B are stacked on the liquid absorber 400 such that the vertical direction of each substrate, that is, the longitudinal direction of each substrate is aligned with the longitudinal direction of the liquid absorber 400. The operator stacks the first substrate 100B on the liquid absorber 400 such that one end E1 in the transverse direction of the first substrate 100B substantially overlaps one end E4 in the transverse direction (width direction) of the liquid absorber 400. The same applies to the arrangement of the second substrate 200B. This embodiment also allows easy positioning of the first substrate 100B and the second substrate 200B.

As in the first embodiment, the liquid absorber 400 can be shared by the first substrate 100B and the second substrate 200B for the liquid leakage detection. Thus, the liquid leakage detector 70 can be more readily formed compared to a case in which the liquid absorber is provided for each of the substrates.

### C. Third Embodiment

In the example of the first embodiment, the pair of electrode terminals are arranged vertically symmetrically at the middle portion of each of the first substrate 100B and the second substrate 200B. However, the pair of electrode terminals do not have to be arranged vertically symmetrically.

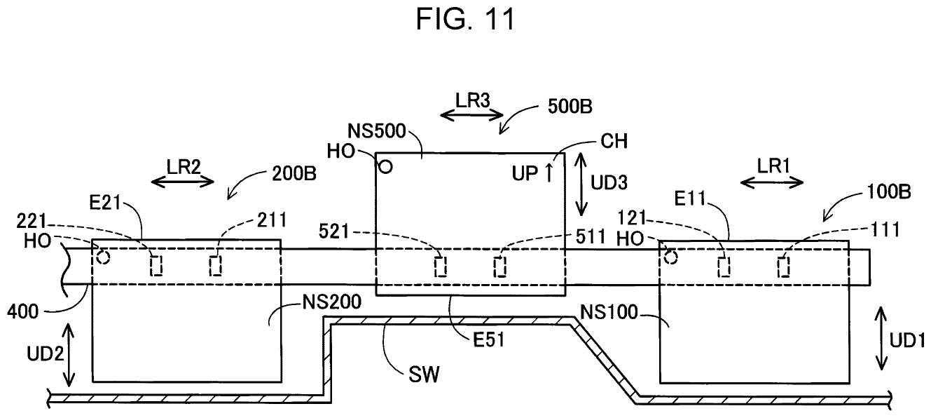

FIG. 11 is an explanatory view illustrating an example of arrangement of the substrates according to the third embodiment. In this embodiment, the first substrate 100B, a third substrate 500B, and the second substrate 200B are connected in series in this order. In FIG. 11, the connectors are not illustrated for convenience. The third substrate 500B has a similar configuration to the second substrate 200B. Electrode terminals 511 and 521 provided on the third substrate 500B function as an ink detector together with the first ink detector 100 and the second ink detector 200. In an example of this embodiment, the side wall SW of the printer 10 has a recessed portion in top view. As illustrated in FIG. 1, the side walls SW of the housing 10h located at ends in the +X direction and the −X direction each have a recessed portion at an end in the +Z direction. The housing 10h has the recessed portions to allow the user to carry the printer 10 by placing the user's hands in them.

In this embodiment, as in the first embodiment, the longitudinal direction of the first substrate 100B is the left-right direction LR1 of the first substrate 100B, and the transverse direction of the first substrate 100B is the vertical direction UD1 of the first substrate. The longitudinal direction of the second substrate 200B is the left-right direction LR2 of the second substrate 200B, and the transverse direction of the second substrate 200B is the vertical UD2 of the second substrate. The longitudinal direction of the third substrate 500B is a left-right direction LR3 of the third substrate 500B, and the transverse direction of the third substrate 500B is a vertical direction UD3 of the third substrate.

In this embodiment, the electrode terminals 111 and 121 are arranged in the left-right direction LR1 on the first substrate 100B. The left-right direction LR1 of the first substrate 100B is also referred to as the “first direction”. The electrode terminals 111 and 121 are located closer to one end E11 of the first substrate 100B in the vertical direction UD1. The end E11 is one of ends of the first substrate 100B in the vertical direction UD1 and is farther from the side wall SW than the other end. In this way, the electrode terminals 111 and 121 are arranged vertically asymmetrically and bilaterally symmetrically on the surface DS100. The electrode terminals 211 and 221 of the second substrate 200B are arranged in the same manner as those of the first substrate 100B.

The electrode terminals 511 and 521 are arranged in the left-right direction LR3 on a surface DS500 of the third substrate 500B. The electrode terminals 511 and 521 are located closer to one end E51 of the third substrate 500B in the vertical direction UD3. The end E51 is one of ends of the third substrate 500B in the vertical direction UD3 and is closer to the side wall SW than the other end. The electrode terminals 511 and 521 are arranged vertically asymmetrically and bilaterally symmetrically on the surface DS500.

As illustrated in FIG. 11, the substrates are arranged so that the electrode terminals of the substrates are in contact with the liquid absorber 400. Furthermore, since the substrates can be arranged along the shape of the side wall SW of the housing of the printer 10, the space in the printer 10 can be efficiently used. Depending on the shape of the housing of the printer 10, it may be convenient that the pair of electrode terminals are not arranged vertically symmetrically and bilaterally symmetrically on the substrate to allow the liquid absorber 400 to be shared by the substrates. In such a case, the configuration according to this embodiment can be employed.

Also in this embodiment, the liquid absorber 400 can be shared by the first substrate 100B, the second substrate 200B, and the third substrate 500B for the liquid leakage detection. Thus, the liquid leakage detector 70 can be more readily formed compared to a case in which the liquid absorber is provided for each of the substrates.

In the example illustrated in FIG. 11, if the substrates are arranged upside down, some of the electrode terminals may fail to be in contact with the liquid absorber 400. To prevent such a problem, each substrate may have a mark indicating the upper side or the lower side of the substrate. The mark may be, for example, a character printed on the substrate, a through hole formed in the substrate, or a notch formed in the substrate. In the example illustrated in FIG. 11, the third substrate 500B has printed characters CH indicating the upper side of the third substrate 500B. The first substrate 100B, the second substrate 200B, and the third substrate 500B each have a through hole HO that indicates the upper side. The marks allow the operator to easily identify the upper and lower sides of the substrate. Thus, the operator is unlikely to incorrectly position the substrate upside down. The surface that has the marks may be the surface DS100 having the electrode terminals or may be the opposite surface NS100. Alternatively, the surface that has the marks may be a portion of the housing of the printer 10 that faces the surface DS100 or the surface NS100.

### D. Other Embodiments

(D1) In the examples of the first embodiment and the other embodiments, the first substrate 300B and the second substrate 100B are connected in series to the control board 200B, but three or more substrates each provided with an ink detector may be connected in series. For example, four substrates each provided with the ink detector may be connected in series such that, for each of the ink cartridges IC1 to IC4, the ink detector is located in the vicinity of the connection between the ink cartridge and the liquid flow unit 20. In other words, one first substrate 100B and three second substrates 200B may be connected in series. In this case, as in the above-described embodiment, ink leakage can be readily detected. In addition, the number of substrates provided with the ink detector can be increased or decreased depending on the number of places where liquid leakage is to be detected, allowing highly flexible placement of the liquid leakage detector 70 inside the printer 10.

(D2) In the example of the first embodiment, the liquid leakage detector 70 is configured to detect a conduction failure with the substrates, but the liquid leakage detector 70 does not have to have the components for detecting a conduction failure, such as the wiring line 130 of the first substrate 100B, the wiring line 230 of the second substrate 200B, and the power supply Vdd2.

(D3) In the example of the first embodiment, the comparator 306 is used to detect the occurrence of a short circuit between the pair of electrode terminals. Instead of the comparator 306, an A/D converter may be used.

(D4) In the examples of the first embodiment and the other embodiments, the first ink detector 100 and the second ink detector 200 are located below the connection between the case and the liquid flow unit 20, but this should not be construed as limiting. The substrate provided with the first ink detector 100 and the substrate provided with the second ink detector 200 may be located, for example, around the print head 31, under the carriage 34, or under the pump 25.

(D5) In the example of the first embodiment, the wiring line 120 and the wiring line 130 are electrically connected to each other using the resistor R0 of 0 ohm as illustrated in FIG. 4. However, the wiring line 120 and the wiring line 130 may be directly connected to each other.

(D6) In the example of the first embodiment, the electrode terminals 111 and 121 are arranged in the left-right direction LR1 on the surface DS100 of the first substrate 100B. However, the electrode terminals 111 and 121 may be arranged in the vertical direction UD1 on the surface DS100 of the first substrate 100B. In this case, the vertical direction of the first substrate 100B is referred to as the “first direction”. The same applies to the electrode terminals 211 and 221 arranged on the second substrate 200B. In this case, the vertical direction of the second substrate 200B is referred to as the “second direction”.

(D7) As illustrated in FIG. 10, when the first substrate 100B and the second substrate 200B are stacked on the liquid absorber 400 such that the longitudinal direction of each substrate is aligned with the longitudinal direction of the liquid absorber 400, the electrode terminals 111 and 121 do not have to be arranged vertically symmetrically on the first substrate 100B. In this case, the electrode terminals 111 and 121 are arranged vertically asymmetrically and horizontally asymmetrically on the surface DS100. The same applies to the second substrate 200B. Even when the first substrate 100B and the second substrate 200B are stacked on the liquid absorber 400 with the top and bottom of the substrates reversed, the electrode terminals are in contact with the liquid absorber 400. Thus, the liquid leakage detector 70 can properly detect ink leakage.

(D8) In the examples of the second to third embodiments, the liquid absorber 400 is located below the first substrate 100B and the second substrate 200B in the gravity direction. However, the arrangement of the first substrate 100B, the second substrate 200B, and the liquid absorber 400 is not limited to this.

For example, the liquid absorber 400 may be located above the first substrate 100B and the second substrate 200B in the gravity direction. In this case, the substrates are located with the surfaces having the electrode terminals facing upward. Alternatively, the liquid absorber 400 may be located along a side wall of the housing of the printer 10, and the first substrate 100B and the second substrate 200B may be stacked on the liquid absorber 400. In this case, the substrates are located with the surfaces having the electrode terminals facing the liquid absorber 400.

(D9) The shape of the substrate, which is provided with the pair of electrode terminals that function as the ink detector, is not limited to a rectangular shape. For example, the substrate may be circular, elliptical, square, or trapezoidal. Furthermore, the shape of the substrate may be a polygon such as a pentagon or a hexagon.

The present disclosure is not limited to the above-described embodiments and can be realized in various configurations without departing from the gist of the present disclosure. For example, the technical features in the embodiments corresponding to the technical features in the aspects described in SUMMARY of the disclosure can be replaced or combined as appropriate in order to solve some or all of the problems described above or in order to achieve some or all of the effects described above. In addition, unless the technical features are described as essential in the present specification, the technical features can be omitted as appropriate.

### E. Other Aspects

(1) An aspect of the present disclosure provides a liquid leakage detector provided inside an ink jet recording apparatus. The liquid leakage detector comprises a first substrate provided with a pair of electrode terminals that function as a first ink detector, a second substrate provided with another pair of electrode terminals that function as a second ink detector, and a control board provided with a detection circuit configured to detect liquid leakage. The first substrate, the second substrate, and the control board are electrically connected in series in this order, and the first substrate is not electrically directly connected to the control board. The detection circuit detects liquid leakage by detecting, through the second substrate, that a potential difference between the pair of electrode terminals or between the other pair of electrode terminals falls below a predetermined threshold value.

In the above aspect, the first substrate, the second substrate, and the control board are electrically connected in series in this order, and the first substrate is not electrically directly connected to the control board, and thus the above aspect requires a smaller space occupied by the wiring lines connecting the substrates in the ink jet recording apparatus than the configuration in which the first substrate and the second substrate are each electrically directly connected to the control board. This enables the space inside the ink jet recording apparatus to be used more efficiently.

(2) In the liquid leakage detector of the above aspect, the pair of electrode terminals may be constituted by an exposed conductor portion of a first wiring line on the first substrate and an exposed conductor portion of a second wiring line on the first substrate. The other pair of electrode terminals may be constituted by an exposed conductor portion of a third wiring line on the second substrate and an exposed conductor portion of a fourth wiring line on the second substrate. The first wiring line and the second wiring line may be arranged in parallel, and the third wiring line and the fourth wiring line may be arranged in parallel. The first wiring line and the third wiring line may be electrically connected in series, and the second wiring line and the fourth wiring line may be electrically connected in series. The third wiring line may be electrically directly connected to the detection circuit, and the fourth wiring line may be grounded. The detection circuit may output a signal indicating detection of liquid leakage when detecting a short circuit between the pair of electrode terminals or a short circuit between the other pair of electrode terminals based on detection of a voltage drop in the first wiring line or the third wiring line. The above aspect enables detection of liquid leakage in the ink jet recording apparatus with a simple configuration.

(3) In the liquid leakage detector of the above aspect, the first substrate may further have a fifth wiring line, and the first wiring line, the second wiring line, and the fifth wiring line may be arranged in parallel. The second wiring line and the fifth wiring line may be electrically connected to each other via a resistor. The second substrate may further have a sixth wiring line, and the third wiring line, the fourth wiring line, and the sixth wiring line may be arranged in parallel. The fifth wiring line and the sixth wiring line may be electrically connected in series. An end of the second wiring line that is not connected to the fourth wiring line and an end of the fifth wiring line that is not connected to the sixth wiring line may be electrically connected to each other. The second wiring line and the fourth wiring line, and the fifth wiring line and the sixth wiring line may constitute one current path, and when the current path is not electrically conducting, the detection circuit may output a signal indicating that the current path is not electrically conducting.

The above aspect enables easy detection of a conduction failure with the substrates connected to the control board. The number of wiring lines on the first substrate and the second substrate can be reduced by using the first wiring line and the third wiring line for both the detection of occurrence of liquid leakage and the detection of a conduction failure with the substrate.

(4) In the liquid leakage detector of the above aspect, the detection circuit may include a leakage signal terminal electrically connected to the third wiring line, a ground terminal electrically connected to the fourth wiring line, a link signal terminal electrically connected to the sixth wiring line, a first pull-up resistor having one end connected to a high potential side of signal potentials used by the detection circuit, and a second pull-up resistor having one end connected to the high potential side of the signal potentials used by the detection circuit. The ground terminal may be grounded, the leakage signal terminal may be connected to the other end of the first pull-up resistor, and the link signal terminal may be connected to the other end of the second pull-up resistor.

(5) In the liquid leakage detector of the above aspect, the detection circuit may include a comparator configured to detect a voltage drop in the third wiring line or a voltage drop in the first wiring line connected to the third wiring line.

(6) In the liquid leakage detector of the above aspect, the detection circuit may include an A/D converter configured to detect a voltage drop in the third wiring line or a voltage drop in the first wiring line connected to the third wiring line.

(7) The liquid leakage detector of the above aspect may further include a liquid absorber having a band shape and configured to absorb liquid, the pair of electrode terminals may be arranged on a first surface of the first substrate in a first direction set for the first substrate, the other pair of electrode terminals may be arranged on a second surface of the second substrate in a second direction set for the second substrate, the first substrate may be on the liquid absorber with the first surface facing the liquid absorber and the first direction being aligned with a longitudinal direction of the liquid absorber, causing the pair of electrode terminals to be in contact with the liquid absorber, and the second substrate may be on the liquid absorber with the second surface facing the liquid absorber and the second direction being aligned with the longitudinal direction of the liquid absorber, causing the other pair of electrode terminals to be in contact with the liquid absorber.

When the liquid absorber absorbs the liquid that has leaked inside the ink jet recording apparatus, a short circuit may occur between the pair of electrode terminals of the first substrate or between the other pair of electrode terminals of the second substrate, which are stacked on the liquid absorber. The above aspect allows the liquid absorber to be shared by the first ink detector and the second ink detector. The liquid leakage detector can be more readily formed compared to a case in which the liquid absorber is provided for each of the substrates. In addition, the operator only has to stack the first substrate on the liquid absorber such that the first direction of the first substrate is aligned with the longitudinal direction of the liquid absorber and stack the second substrate on the liquid absorber such that the second direction of the second substrate is aligned with the longitudinal direction of the liquid absorber. Thus, the positioning of the first substrate and the second substrate is easy.

(8) In the above liquid leakage detector, the first substrate and the second substrate each may have a rectangular shape, a longitudinal direction of the first substrate may be the first direction, a longitudinal direction of the second substrate may be the second direction, the pair of electrode terminals may be arranged in the first direction to at least partially overlap a first virtual center line that is a virtual straight line positioned at a center in a transverse direction of the first substrate, and the other pair of electrode terminals may be arranged in the second direction to at least partially overlap a second virtual center line that is a virtual straight line positioned at the center in a transverse direction of the second substrate.

In the above aspect, the pair of electrode terminals are arranged to at least partially overlap the first virtual center line set for the first substrate, and thus the first substrate can be readily positioned with respect to the liquid absorber having a band shape. Although the first substrate should be placed such that the pair of electrode terminals are in contact with the liquid absorber, the pair of electrode terminals may fail to at least partially overlap the first virtual center line set for the first substrate. In such a case, if the substrate is turned upside down, the pair of electrode terminals are not in contact with the liquid absorber. The above aspect can prevent the problem that the pair of electrode terminals are not in contact with the liquid absorber, even if the substrate is turned upside down. The same applies to the second substrate.

(9) In the liquid leakage detector of the above aspect, a direction intersecting the longitudinal direction of the first substrate may be a vertical direction of the first substrate, a direction intersecting the longitudinal direction of the second substrate may be a vertical direction of the second substrate, the pair of electrode terminals may be arranged vertically symmetrically and bilaterally symmetrically on the first surface of the first substrate, and the other pair of electrode terminals may be arranged vertically symmetrically and bilaterally symmetrically on the second surface of the second substrate.

In the above aspect, the pair of electrode terminals and the other pair of electrode terminals only have to be arranged vertically symmetrically and bilaterally symmetrically on each substrate, and thus the electrode terminals can be readily positioned.

(10) In the liquid leakage detector of the above aspect, the first substrate and the second substrate each may have a rectangular shape, a direction intersecting the longitudinal direction of the first substrate may be a vertical direction of the first substrate, a direction intersecting the longitudinal direction of the second substrate may be a vertical direction of the second substrate, the pair of electrode terminals may be arranged bilaterally symmetrically and vertically asymmetrically on the first surface of the first substrate, and the other pair of electrode terminals may be arranged bilaterally symmetrically and vertically asymmetrically on the second surface of the second substrate.

(11) In the liquid leakage detector of the above aspect, the first substrate may have a mark indicating an upper side of the first surface, and the second substrate may have a mark indicating an upper side of the second surface.

The above aspect makes it easy for an operator who places the first substrate and the second substrate to identify the upper and lower sides of the substrates.

(12) Another aspect of the present disclosure provides an ink jet recording apparatus. The ink jet recording apparatus includes a liquid flow unit, an ejection execution unit, a case housing, a control unit, and a liquid leakage detector. The liquid leakage detector includes a first substrate provided with a pair of electrode terminals that function as a first ink detector, a second substrate provided with another pair of electrode terminals that function as a second ink detector, and a control board provided with a detection circuit configured to detect liquid leakage. The first substrate, the second substrate, and the control board are electrically connected in series in this order, and the first substrate is not electrically directly connected to the control board. The detection circuit detects liquid leakage by detecting, through the second substrate, that a potential difference between the pair of electrode terminals or between the other pair of electrode terminals falls below a predetermined threshold value.

In the above aspect, the first substrate, the second substrate, and the control board are electrically connected in series in this order, and the first substrate is not electrically directly connected to the control board, and thus the above aspect requires a smaller space occupied by the wiring lines connecting the substrates in the ink jet recording apparatus than the configuration in which the first substrate and the second substrate are each electrically directly connected to the control board. This enables the space inside the ink jet recording apparatus to be used more efficiently.

The present disclosure is not limited to the aspect in the form of the ink jet recording apparatus described above and can be achieved in various forms such as an ink jet system and a multifunction peripheral including the ink jet recording apparatus.

What is claimed is:

1. A liquid leakage detector provided inside an ink jet recording apparatus, comprising:
a first substrate provided with a pair of electrode terminals that function as a first ink detector;
a second substrate provided with another pair of electrode terminals that function as a second ink detector; and
a control board provided with a detection circuit configured to detect liquid leakage, wherein
the first substrate, the second substrate, and the control board are electrically connected in series in this order,
the first substrate is not electrically directly connected to the control board, and
the detection circuit detects liquid leakage by detecting, through the second substrate, that a potential difference between the pair of electrode terminals or between the other pair of electrode terminals falls below a predetermined threshold value.

2. The liquid leakage detector according to claim 1, wherein
the pair of electrode terminals are constituted by an exposed conductor portion of a first wiring line on the first substrate and an exposed conductor portion of a second wiring line on the first substrate,
the other pair of electrode terminals are constituted by an exposed conductor portion of a third wiring line on the second substrate and an exposed conductor portion of a fourth wiring line on the second substrate,
the first wiring line and the second wiring line are arranged in parallel,
the third wiring line and the fourth wiring line are arranged in parallel,
the first wiring line and the third wiring line are electrically connected in series,
the second wiring line and the fourth wiring line are electrically connected in series,
the third wiring line is electrically directly connected to the detection circuit,
the fourth wiring line is grounded, and
the detection circuit outputs a signal indicating detection of liquid leakage
when detecting a short circuit between the pair of electrode terminals or a short circuit between the other pair of electrode terminals based on detection of a voltage drop in the first wiring line or the third wiring line.

3. The liquid leakage detector according to claim 2, wherein the first substrate further has a fifth wiring line,
the first wiring line, the second wiring line, and the fifth wiring line are arranged in parallel,
the second wiring line and the fifth wiring line are electrically connected to each other via a resistor,
the second substrate further has a sixth wiring line,
the third wiring line, the fourth wiring line, and the sixth wiring line are arranged in parallel,
the fifth wiring line and the sixth wiring line are electrically connected in series,
an end of the second wiring line that is not connected to the fourth wiring line and an end of the fifth wiring line that is not connected to the sixth wiring line are electrically connected to each other,
the second wiring line, the fourth wiring line, the fifth wiring line, and the sixth wiring line constitute one current path, and
when the current path is not electrically conducting, the detection circuit outputs a signal indicating that the current path is not electrically conducting.

4. The liquid leakage detector according to claim 3, wherein the detection circuit includes:
a leakage signal terminal electrically connected to the third wiring line;
a ground terminal electrically connected to the fourth wiring line;
a link signal terminal electrically connected to the sixth wiring line;
a first pull-up resistor having an end connected to a high potential side of signal potentials used by the detection circuit; and
a second pull-up resistor having one end connected to the high potential side of the signal potentials used by the detection circuit,
the ground terminal is grounded,
the leakage signal terminal is connected to the other end of the first pull-up resistor, and
the link signal terminal is connected to the other end of the second pull-up resistor.

5. The liquid leakage detector according to claim 4, wherein
the detection circuit includes a comparator configured to detect a voltage drop in the third wiring line or a voltage drop in the first wiring line connected to the third wiring line.

6. The liquid leakage detector according to claim 4, wherein
the detection circuit includes an A/D converter configured to detect a voltage drop in the third wiring line or a voltage drop in the first wiring line connected to the third wiring line.

7. The liquid leakage detector according to claim 1, further comprising a liquid absorber having a band shape and configured to absorb liquid, wherein
the pair of electrode terminals are arranged on a first surface of the first substrate in a first direction set for the first substrate,
the other pair of electrode terminals are arranged on a second surface of the second substrate in a second direction set for the second substrate,
the first substrate is on the liquid absorber with the first surface facing the liquid absorber and the first direction being aligned with a longitudinal direction of the liquid absorber, causing the pair of electrode terminals to be in contact with the liquid absorber, and
the second substrate is on the liquid absorber with the second surface facing the liquid absorber and the second direction being aligned with the longitudinal direction of the liquid absorber, causing the other pair of electrode terminals to be in contact with the liquid absorber.

8. The liquid leakage detector according to claim 7, wherein
the first substrate and the second substrate each have a rectangular shape,
a longitudinal direction of the first substrate is the first direction,
a longitudinal direction of the second substrate is the second direction,
the pair of electrode terminals are arranged in the first direction to at least partially overlap a first virtual center line that is a virtual straight line positioned at a center in a transverse direction of the first substrate, and
the other pair of electrode terminals are arranged in the second direction to at least partially overlap a second virtual center line that is a virtual straight line positioned at the center in a transverse direction of the second substrate.

9. The liquid leakage detector according to claim 8, wherein
a direction intersecting the longitudinal direction of the first substrate is a vertical direction of the first substrate,
a direction intersecting the longitudinal direction of the second substrate is a vertical direction of the second substrate,
the pair of electrode terminals are arranged vertically symmetrically and bilaterally symmetrically on the first surface of the first substrate, and
the other pair of electrode terminals are arranged vertically symmetrically and bilaterally symmetrically on the second surface of the second substrate.

10. The liquid leakage detector according to claim 7, wherein
the first substrate and the second substrate each have a rectangular shape,
a direction intersecting the longitudinal direction of the first substrate is a vertical direction of the first substrate,
a direction intersecting the longitudinal direction of the second substrate is a vertical direction of the second substrate,
the pair of electrode terminals are arranged bilaterally symmetrically and vertically asymmetrically on the first surface of the first substrate, and
the other pair of electrode terminals are arranged bilaterally symmetrically and vertically asymmetrically on the second surface of the second substrate.

11. The liquid leakage detector according to claim 7, wherein
the first substrate has a mark indicating an upper side of the first surface, and
the second substrate has a mark indicating an upper side of the second surface.

12. An ink jet recording apparatus including a liquid flow unit, an ejection execution unit, a case housing, a control unit, and a liquid leakage detector, wherein
the liquid leakage detector comprises:
a first substrate provided with a pair of electrode terminals that function as a first ink detector;
a second substrate provided with another pair of electrode terminals that function as a second ink detector; and
a control board provided with a detection circuit configured to detect liquid leakage, wherein
the first substrate, the second substrate, and the control board are electrically connected in series in this order,
the first substrate is not electrically directly connected to the control board, and
the detection circuit detects liquid leakage by detecting, through the second substrate, that a potential difference between the pair of electrode terminals or between the other pair of electrode terminals falls below a predetermined threshold value.
